(19) United States
(12) Patent Application Publication
(10) Pub. No.: US 2019/0163461 A1
(43) Pub. Date: May 30, 2019

(54) UPGRADE MANAGERS FOR DIFFERENTIAL UPGRADE OF DISTRIBUTED COMPUTING SYSTEMS

(71) Applicant: Nutanix, Inc., San Jose, CA (US)

(72) Inventors: Anand Jayaraman, San Jose, CA (US); Arpit Singh, San Jose, CA (US); Daniel Shubin, San Jose, CA (US); Nikhil Bhatia, San Jose, CA (US); Preeti Upendra Murthy, San Jose, CA (US)

(73) Assignee: Nutanix, Inc., San Jose, CA (US)

(21) Appl. No.: 15/825,905

(22) Filed: Nov. 29, 2017

(51) Int. Cl. G06F 9/445; G06F 9/455

(52) U.S. Cl. CPC G06F 8/65; G06F 9/44505; G06F 9/45558

(57) ABSTRACT

Examples of systems described herein may advantageously facilitate a software upgrade of one or more computing nodes of a distributed system without requiring a reboot of the node or otherwise rendering the node completely unavailable during upgrade. Upgrade portals described herein may provide each computing node with only the differential data needed to upgrade the node. Upgrade managers at each computing node may upgrade software at the computing node based on the differential data and restart services effected by the upgrade using the differential data. Other services may remain available during the restart of the effected services.

### TECHNICAL FIELD

Examples described herein relate to virtualized and/or distributed computing systems. Examples of computing systems utilizing an upgrade manager to facilitate software upgrades of computing node(s) in the system are described.

### BACKGROUND

Software upgrades of computing systems can often take an undesirable amount of time and/or may transfer an undesirably large amount of data to perform the upgrade.

When a computing node of a distributed system is powered off or becomes otherwise unavailable during a software upgrade, the remainder of the distributed system may need to operate using redundancy configurations.

In an example of a four node cluster, an upgrade may require 4 GB of data per cluster, which would be downloaded to each node. For the four nodes, that means a total of 16 GB of data being transferred in support of the upgrade.

### BRIEF DESCRIPTION OF THE DRAWINGS

FIG. 1 is a block diagram of a distributed computing system, in accordance with an embodiment of the present invention.

FIG. 2 is a schematic illustration of a system arranged in accordance with examples described herein.

FIG. 3 is a flowchart of a method arranged in accordance with examples described herein.

FIG. 4 depicts a block diagram of components of a computing node in accordance with examples described herein.

### DETAILED DESCRIPTION

Certain details are set forth herein to provide an understanding of described embodiments of technology. However, other examples may be practiced without various of these particular details. In some instances, well-known virtualized and/or distributed computing system components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented here.

Examples of systems described herein may advantageously facilitate a software upgrade of one or more computing nodes of a distributed system without requiring a reboot of the node or otherwise rendering the node completely unavailable during upgrade.

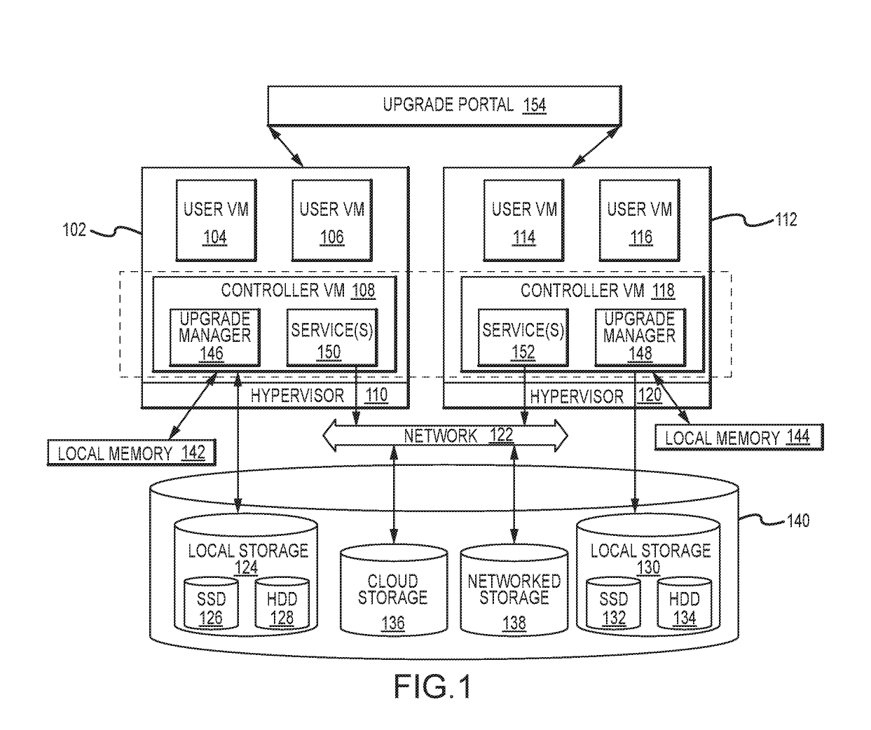

FIG. 1 is a block diagram of a distributed computing system, in accordance with an embodiment of the present invention. The distributed computing system of FIG. 1 generally includes computing node 102 and computing node 112 and storage 140 connected to a network 122. The network 122 may be any type of network capable of routing data transmissions from one network device (e.g., computing node 102, computing node 112, and storage 140) to another. For example, the network 122 may be a local area network (LAN), wide area network (WAN), intranet, Internet, or a combination thereof. The network 122 may be a wired network, a wireless network, or a combination thereof.

The storage 140 may include local storage 124, local storage 130, cloud storage 136, and networked storage 138. The local storage 124 may include, for example, one or more solid state drives (SSD 126) and one or more hard disk drives (HDD 128). Similarly, local storage 130 may include SSD 132 and HDD 134. Local storage 124 and local storage 130 may be directly coupled to, included in, and/or accessible by a respective computing node 102 and/or computing node 112 without communicating via the network 122. Cloud storage 136 may include one or more storage servers that may be stored remotely to the computing node 102 and/or computing node 112 and accessed via the network 122. The cloud storage 136 may generally include any type of storage device, such as HDDs SSDs, or optical drives. Networked storage 138 may include one or more storage devices coupled to and accessed via the network 122. The networked storage 138 may generally include any type of storage device, such as HDDs SSDs, or optical drives. In various embodiments, the networked storage 138 may be a storage area network (SAN).

The computing node 102 is a computing device for hosting VMs in the distributed computing system of FIG. 1. The computing node 102 may be, for example, a server computer, a laptop computer, a desktop computer, a tablet computer, a smart phone, or any, other type of computing device. The computing node 102 may include one or more physical computing components, such as processors.

The computing node 102 is configured to execute a hypervisor 110, a controller VM 108 and one or more user VMs, such as user VMs 104, 106. The user VMs including user VM 104 and user VM 106 are virtual machine instances executing on the computing node 102. The user VMs including user VM 104 and user VM 106 may share a virtualized pool of physical computing resources such as physical processors and storage (e.g., storage 140). The user VMs including user VM 104 and user VM 106 may each have their own operating system, such as Windows or Linux. While a certain number of user VMs are shown, generally any number may be implemented.

The hypervisor 110 may be any type of hypervisor. For example, the hypervisor 110 may be ESX, ESX(i), Hyper-V, KVM, or any other type of hypervisor. The hypervisor 110 manages the allocation of physical resources (such as storage 140 and physical processors) to VMs (e.g., user VM 104, user VM 106, and controller VM 108) and performs various VM related operations, such as creating new VMs and cloning existing VMs. Each type of hypervisor may have a hypervisor-specific API through which commands to perform various operations may be communicated to the particular type of hypervisor.

Controller VMs (CVMs) described herein, such as the controller VM 108 and/or controller VM 118, may provide services for the user VMs in the computing node. As an example of functionality that a controller VM may provide, the controller VM 108 may provide virtualization of the storage 140. Controller VMs may provide management of the distributed computing system shown in FIG. 1. Examples of controller VMs may execute a variety of software and/or may serve the I/O operations for the hypervisor and VMs running on that node. In some examples, a SCSI controller, which may manage SSD and/or HDD devices described herein, may be directly passed to the CVM, e.g., leveraging VM-Direct Path. In the case of Hyper-V, the storage devices may be passed through to the CVM.

The computing node 112 may include user VM 114, user VM 116, a controller VM 118, and a hypervisor 120. The user VM 114, user VM 116, the controller VM 118, and the hypervisor 120 may be implemented similarly to analogous components described above with respect to the computing node 102. For example, the user VM 114 and user VM 116 may be implemented as described above with respect to the user VM 104 and user VM 106. The controller VM 118 may be implemented as described above with respect to controller VM 108. The hypervisor 120 may be implemented as described above with respect to the hypervisor 110. In the embodiment of FIG. 1, the hypervisor 120 may be a different type of hypervisor than the hypervisor HO. For example, the hypervisor 120 may be Hyper-V, while the hypervisor 110 may be ESX(i).

The controller VM 108 and controller VM 118 may communicate with one another via the network 122. By linking the controller VM 108 and controller VM 118 together via the network 122, a distributed network of computing nodes including computing node 102 and computing node 112, can be created.

Controller VMs, such as controller VM 108 and controller VM 118, may each execute a variety of services and may coordinate, for example, through communication over network 122. For example, service(s) 150 may be executed by controller VM 108. Service(s) 152 may be executed by controller VM 118. Services running on controller VMs may utilize an amount of local memory to support their operations. For example, service(s) 150 running on controller VM 108 may utilize memory in local memory 142. Service(s) 152 running on controller VM 118 may utilize memory in local memory 144. Multiple instances of the same service may be running throughout the distributed system—e.g. a same services stack may be operating on each controller VM. For example, an instance of a service may be running on controller VM 108 and a second instance of the service may be running on controller VM 118. Generally, a service may refer to software which performs a functionality or a set of functionalities (e.g., the retrieval of specified information or the execution of a set of operations) with a purpose that different clients (e.g, different VMs described herein) can reuse for different purposes. The service may further refer to the policies that should control usage of the software function (e.g., based on the identity of the client requesting the service). For example, a service may provide access to one or more capabilities using a prescribed interface and consistent with constraints and/or policies enforced by the service.

Examples of computing nodes described herein may include an upgrade manager, such as upgrade manager 146 of computing node 102 and upgrade manager 148 of computing node 112. In some examples, the upgrade manager may be provided by one or more controller VMs, as shown in FIG. 1—e.g., the upgrade manager 146 may be part of controller VM 108 and the upgrade manager 148 may be part of controller VM 118. Upgrade managers described herein may in some examples facilitate upgrade of one or more service(s) provided by computing nodes in a system. In some examples, the upgrade managers may facilitate the upgrade of one or more services provided by a computing node without a need to restart the computing node.

Examples of computing nodes described herein may include an upgrade portal, such as upgrade portal 154. The upgrade portal may be in communication with one or more computing nodes in a system, such as computing node 102 and computing node 112 of FIG. 1. The upgrade portal 154 may be hosted in some examples by another computing system, connected to the computing nodes over a network (e.g., network 122). However, in some examples, the upgrade portal 154 may be hosted by one of the computing nodes—e.g., computing node 102 and/or computing node 112 of FIG. 1. The upgrade portal 154 may compare software packages of a software upgrade with software packages hosted on each of the computing nodes of the computing system, and may generate differential upgrade data for each of the computing nodes.

A user interface (not shown in FIG. 1) may be provided for the upgrade portal 154. The user interface may allow a user (e.g., an administrator, and/or in some examples another software process) to view available software upgrades, and select an upgrade to perform. The user interface may allow the user to provide an indication to upgrade software of the computing system.

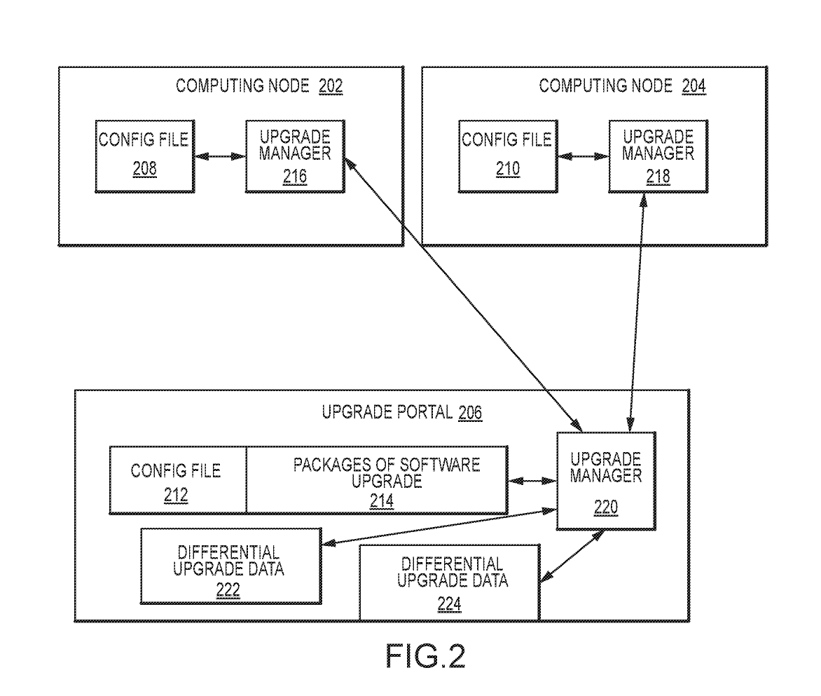

FIG. 2 is a schematic illustration of a system arranged in accordance with examples described herein. FIG. 2 includes computing node 202, computing node 204, and upgrade portal 206. The computing node 202 includes upgrade manager 216 and config file 208. The computing node 204 includes config file 210 and config file 212. The upgrade portal 206 includes packages of software upgrade 214, upgrade manager 216, upgrade manager 218, upgrade manager 220, differential upgrade data 222, and differential upgrade data 224. The upgrade portal 206 may be in communication with computing node 202 and computing node 204 (e.g., over one or more networks). The computing node 202 and computing node 204 may be in communication with one another (e.g., over one or more networks). The system of FIG. 2 may be used to implement and/or may be implemented by the system shown in FIG. 1. For example, the computing node 202 may be used to implement and/or may be implemented by computing node 102 of FIG. 1. The computing node 204 may be used to implement and/or may be implemented by computing node 112 of FIG. 1. The upgrade portal 206 may be used to implement and/or may be implemented by the upgrade portal 154 of FIG. 1. The computing nodes shown in FIG. 2 omit certain details which may be present (e.g., controller VMs, user VMs, hypervisors) for clarity in describing upgrade functionality.

Generally, each computing node of a system described herein may include an upgrade manager which may be used to upgrade software hosted by the computing node. Upgrade manager 216 may be used to upgrade software of computing node 204. Upgrade manager 218 may be used to upgrade software of upgrade portal 206. Each computing node may store information regarding software packages currently hosted by the computing system. For example, the information regarding the software packages may be stored as one or more configuration (config) files. The configuration files may specify, for example, a version number and/or installation date and/or creation date of software packages hosted by the computing node (e.g., software packages running on one or more controller VMs). A software package generally refers to a collection of software and/or data together with metadata, such as the software's name, description, version number, vendor, checksum, and/or list of dependencies for proper operation of the software package. The configuration files accordingly may provide data regarding a current version of software packages operating on each of the computing nodes of a distributed system. For example, the config file 208 may provide data regarding the software packages hosted by the computing node 202. The config file 210 may provide data regarding the software packages hosted by the computing node 204. The upgrade manager on each computing node may transmit the config file for the computing node to an upgrade portal described herein, such as upgrade portal 206.

The upgrade portal 206 may store one or more software upgrades. A complete software upgrade may be large, and it may be undesirable to transmit the entire software upgrade to one or more of the computing nodes in a distributed system. Accordingly, upgrade portals described herein may compare a software upgrade with software packages currently installed on one or more computing nodes. For example, upgrade portal 206 may receive data regarding software packages installed on the computing node 202 and computing node 204. For example, upgrade portal 206 may receive the config file 208 from computing node 202 and config file 210 from computing node 204. In other examples, the upgrade portal 206 may receive a checksum of the config file 208 from computing node 202 and a checksum of config file 210 from computing node 204. The upgrade portal 206 may itself store and/or access a configuration file (e.g., config file 212) associated with the packages of the software upgrade, e.g., packages of software upgrade 214. The upgrade portal 206 may compare the data received regarding software packages installed on the computing nodes (e.g., config file 208 and config file 210) with the software upgrade (e.g., with config file 212). This comparison may indicate which of the software packages on each computing node need to be upgraded to implement the software upgrade. The upgrade portal 206 may accordingly provide differential upgrade data for each computing node. For example, differential upgrade data 222 may be prepared based on a comparison between config file 208 and config file 212. Differential upgrade data 224 may be prepared based on a comparison between config file 210 and config file 212. The differential upgrade data 222 may be provided to computing node 202. The differential upgrade data 224 may be provided to computing node 204. The differential upgrade data 222 and the differential upgrade data 224 may be different, depending on differences in the existing packages on the two computing nodes. The differential upgrade data may include selected packages for upgrade at the computing node.

While the upgrade portal 206 is shown as a separate system in FIG. 2, in some examples the upgrade portal 206 may be integral with the computing node 202 and/or computing node 204.

On receipt of the differential upgrade data, upgrade managers described herein may, upgrade the software at their respective computing nodes and restart selected (e.g., effected) services. During the restart of selected services, other services installed at the computing node may remain available. Accordingly, a computing node may not need to become unavailable for the purposes of upgrade.

For example, the upgrade manager 146 may receive differential upgrade data 222. The differential upgrade data 222 may include certain software packages for update. The upgrade manager 146 may upgrade the software packages. The upgrade itself may happen as follows. The currently-installed software package(s) which may be impacted by the differential upgrade data may be copied and/or moved to an archive copy. The archive copy may be used in the event that it becomes desirable to restore a previous version of the installation. The packages received in the differential upgrade data, e.g., the differential upgrade data 222, may be installed in an appropriate location. In this manner, if the upgrade were to fail prior to installation of the differential upgrade data 222, the computing node may be restored by accessing the archive copy of the software package(s). The upgrade manager 146 may restart services effected by the upgraded software packages. Selected services which utilize the upgraded packages may be restarted such that they utilize the upgraded packages Note that during the restart of the effected services, other services of the computing node may remain available.

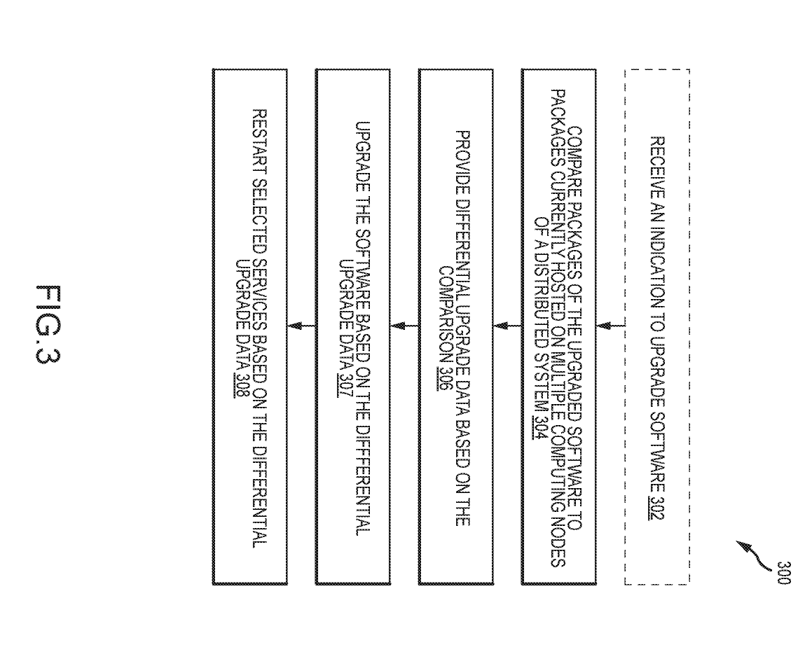

FIG. 3 is a flowchart of a method arranged in accordance with examples described herein. Method 300 includes block 302-block 308. Additional, fewer, and/or different blocks may be used in other examples. Block 302 recites “receive an indication to upgrade software.” Block 302 may be followed by block 304 which recites “compare packages of the upgraded software to packages currently hosted on multiple computing nodes of a distributed system.” Block 304 may be followed by block 306 which recites “provide differential upgrade data based on the comparison.” Block 306 may be followed by block 307 which recites “upgrade the software based on the differential upgrade data.” Block 307 may be followed by block 308 which recites “restart selected services based on the differential upgrade data.”

Block 302 recites “receive an indication to upgrade software.” The indication may be received, for example, by one or more upgrade portals described herein and/or by one or more upgrade managers described herein. The indication may be provided by a user (e.g., an administrator and/or a software process). In some examples, an automated indication to upgrade software may be provided on a periodic basis and/or responsive to notification of one or more new software releases. The software to be upgraded may, for example, be software executing on one or more controller VMs of a distributed system (e.g., controller VM 108 and/or controller VM 118 of FIG. 1).

Block 304 recites “compare packages of the upgraded software to packages currently hosted on multiple computing nodes of a distributed system.” The comparison described in block 304 may be performed, for example by an upgrade portal described herein, such as upgrade portal 154 of FIG. 1 and/or upgrade portal 206 of FIG. 2. The comparison may be based on configuration files. For example, a configuration file associated with software packages currently hosted on a computing node may be compared with a configuration file associated with packages of a software upgrade. The comparison may be performed for each computing node in a distributed computing system. An upgrade portal performing the comparison may receive and/or access the configuration files for the comparison. In some examples, the comparison may include comparing checksums of the configuration files. The upgrade portal may calculate the checksums and/or may receive or access the checksums from the computing nodes.

Block 306 recites “provide differential upgrade data based on the comparison.” The differential upgrade data may be provided by one or more upgrade portals described herein, such as upgrade portal 154 of FIG. 1 and/or upgrade portal 206 of FIG. 2. An upgrade portal may generate the differential upgrade data by selecting certain packages from a software upgrade based on the comparison performed in block 304. The comparison in block 304 may indicate that certain software packages should be updated while others need not be updated to achieve the requested software upgrade. Different differential upgrade data may be provided to each computing node in a distributed computing system. In some examples, however, the differential upgrade data provided to certain computing nodes may be the same (e.g., if the computing nodes were hosting the same versions of all software packages prior to the upgrade). The differential upgrade data for a computing node may be provided to the upgrade manager of that computing node, e.g., over a network. The upgrade manager of the computing node may utilize the differential upgrade data to upgrade the software at the computing node. For example, the upgrade manager may copy existing versions of software packages received in the differential upgrade data to archive versions and replace the existing versions of software packages with those versions received in the differential upgrade data.

Block 307 recites “upgrade the software based on the differential upgrade data.” During upgrade of the software, the currently-installed software package(s) which may be impacted by the differential upgrade data may be copied and/or moved to an archive copy. The archive copy may be used in the event that it becomes desirable to restore a previous version of the installation. The packages received in the differential upgrade data, e.g., the differential upgrade data 222 of FIG. 2, may be installed in an appropriate location. In this manner, if the upgrade were to fail prior to installation of the upgrade, the computing node may be restored using archive copies of the packages.

Block 308 recites “restart selected services based on the differential upgrade data.” Upgrade managers herein may then restart the services on their computing nodes which were effected by the upgrade (e.g., utilize the packages provided in the differential upgrade data and upgraded by the upgrade managers. During the restart of those selected services which were effected by the upgrade, other services provided by the computing node may remain available. No complete restart of the computing node (e.g., no restart of the operating system) may be performed in some examples.

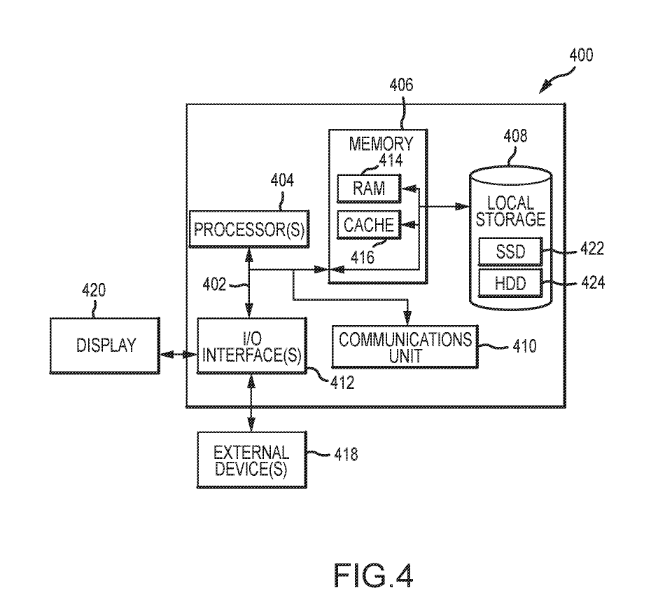

FIG. 4 depicts a block diagram of components of a computing node 400 in accordance with examples described herein. It should be appreciated that FIG. 4 provides only an illustration of one example and does not imply any limitations with regard to the environments in which different embodiments may be implemented. Many modifications to the depicted environment may be made. The computing node 400 may be used to implement and/or may be implemented as the computing node 102 and/or computing node 112 of FIG. 1.

The computing node 400 includes a communications fabric 402, which provides communications between one or more processor(s) 404, memory 406, local storage 408, communications unit 410, I/O interface(s) 412. The communications fabric 402 can be implemented with any architecture designed for passing data and/or control information between processors (such as microprocessors, communications and network processors, etc.), system memory, peripheral devices, and any other hardware components within a system. For example, the communications fabric 402 can be implemented with one or more buses.

The memory 406 and the local storage 408 are computer-readable storage media. In this embodiment, the memory 406 includes random access memory RAM 414 and cache 416. In general, the memory 406 can include any suitable volatile or non-volatile computer-readable storage media. The local storage 408 may be implemented as described above with respect to local storage 124 and/or local storage 130. In this embodiment, the local storage 408 includes an SSD 422 and an HDD 424, which may be implemented as described above with respect to SSD 126, SSD 132 and HDD 128, HDD 134 respectively.

Various computer instructions, programs, files, images, etc. may be stored in local storage 408 for execution by one or more of the respective processor(s) 404 via one or more memories of memory 406. For example, executable instructions for performing the actions described herein as taken by an upgrade manager may be stored wholly or partially in local storage 408 for execution by one or more of the processor(s) 404. As another example, executable instructions for performing the actions described herein as taken by an upgrade portal may be stored wholly or partially in local storage 408 for execution by one or more of the processor(s) 404. In some examples, local storage 408 includes a magnetic HDD 424. Alternatively, or in addition to a magnetic hard disk drive, local storage 408 can include the SSD 422, a semiconductor storage device, a read-only memory (ROM), an erasable programmable read-only memory (EPROM), a flash memory, or any other computer-readable storage media that is capable of storing program instructions or digital information.

The media used by local storage 408 may also be removable. For example, a removable hard drive may be used for local storage 408. Other examples include optical and magnetic disks, thumb drives, and smart cards that are inserted into a drive for transfer onto another computer-readable storage medium that is also part of local storage 408.

Communications unit 410, in these examples, provides for communications with other data processing systems or devices. In these examples, communications unit 410 includes one or more network interface cards. Communications unit 410 may provide communications through the use of either or both physical and wireless communications links.

I/O interface(s) 412 allows for input and output of data with other devices that may be connected to computing node 400. For example, I/O interface(s) 412 may provide a connection to external device(s) 418 such as a keyboard, a keypad, a touch screen, and/or some other suitable input device. External device(s) 418 can also include portable computer-readable storage media such as, for example, thumb drives, portable optical or magnetic disks, and memory cards. Software and data used to practice embodiments of the present invention can be stored on such portable computer-readable storage media and can be loaded onto local storage 408 via I/O interface(s) 412. I/O interface(s) 412 also connect to a display 420.

Display 420 provides a mechanism to display data to a user and may be, for example, a computer monitor.

From the foregoing it will be appreciated that, although specific embodiments have been described herein for purposes of illustration, various modifications may be made while remaining with the scope of the claimed technology.

1. A distributed system comprising:
a first upgrade manager hosted by a first computing node, the first upgrade manager configured to receive first differential upgrade data comprising selected packages for upgrade based on a comparison between existing packages hosted by the first computing node and packages of a software upgrade, and wherein the first upgrade manager is configured to upgrade packages based on the first differential upgrade data and restart selected services of the first plurality of services based on the first differential upgrade data; and
a second upgrade manager hosted by a second computing node, the second upgrade manager configured to receive second differential upgrade data comprising second selected packages for upgrade, different from the first differential upgrade data, based on a comparison between existing packages hosted by the second computing node and the packages of the software upgrade, and wherein the second upgrade manager is configured to upgrade packages based on the second differential upgrade data and restart second selected services of the second plurality of services based on the second differential upgrade data.

2. The distributed system of claim 1, further comprising an upgrade portal, wherein the upgrade portal is configured to compare the existing packages hosted by the first computing node and the packages of the software upgrade and provide the first differential upgrade data.

3. The distributed system of claim 2, wherein the upgrade portal is hosted by the first computing node or the second computing node.

4. The distributed system of claim 2, wherein the upgrade portal is hosted by a computing system other than the first computing node or the second computing node.

5. The distributed system of claim 2, further comprising an upgrade configuration file associated with the packages of the software upgrade and a first configuration file associated with the existing packages hosted by the first computing node, and wherein the upgrade portal is configured to compare the upgrade configuration file and the first configuration file to provide the first differential upgrade data.

6. The distributed system of claim 5, wherein the upgrade portal is configured to compare a checksum of the upgrade configuration file with a checksum of the first configuration file to provide the first differential upgrade data.

7. The distributed system of claim 1, wherein other services of the first plurality of services remain available during restart of the selected services of the first plurality of services.

8. A method comprising:
comparing packages of upgraded software to packages hosted on each of multiple computing nodes to generate first differential upgrade data for a first one of the multiple computing nodes and second differential upgrade data, different than the first differential upgrade data, for a second one of the multiple computing nodes;
transmitting the first differential upgrade data to the first computing node and the second differential upgrade data to the second computing node; and
upgrading software on the first and second computing nodes using the first and second differential upgrade data, respectively.

9. The method of claim 8, further comprising restarting selected services of the multiple computing nodes impacted by the first differential upgrade data and the second differential upgrade data while maintaining availability of other services of the multiple computing nodes.

10. The method of claim 8, wherein the first differential upgrade data is less data than the upgraded software.

11. The method of claim 8, wherein said comparing packages comprises comparing a configuration file of the upgraded software with a configuration file associated with currently-installed packages hosted on each of the first and second computing nodes.

12. The method of claim 11, wherein said comparing packages comprises comparing a checksum of the configuration file of the upgraded software with a checksum of the configuration file associated with the currently-installed packages hosted on each of the first and second computing nodes to provide the first and second differential upgrade data.

13. The method of claim 11, wherein said transmitting the first differential upgrade data comprises transmitting the first differential upgrade data from one of the multiple computing nodes to others of the multiple computing nodes.

14. The method of claim 11, further comprising upgrading software at the multiple computing nodes using the first differential upgrade data and the second differential upgrade data.

15. At least one non-transitory computer readable media encoded with instructions which, when executed cause a computing system to:
receive, at an upgrade portal, first data indicative of installed software packages currently hosted by a first computing node of a distributed system and second data indicative of installed software packages currently hosted by a second computing node of the distributed system; and
provide, from the upgrade portal, first differential upgrade data based on a comparison of the first data with packages of a software upgrade and second differential upgrade data, different than the first differential upgrade data, based on a comparison of the second data with packages of the software upgrade.

16. The at least one non-transitory computer readable media of claim 15, wherein the instructions, when executed, further cause the computing system to cause a restart of selected services hosted by the first computing node based on the first data while maintaining availability of other services during restart of the selected services.

17. The at least one non-transitory computer readable media of claim 15, wherein said receive first data comprises receive a configuration file indicative of the installed software packages currently hosted by the first computing node.

18. The at least one non-transitory computer readable media of claim 17, wherein said first differential upgrade data is based on a comparison of a checksum of the configuration file and a checksum of another configuration file associated with the packages of the software upgrade software upgrade.

19. The at least one non-transitory computer readable media of claim 15, wherein said upgrade portal is hosted by one computing node of the distributed system.

20. The at least one non-transitory computer readable media of claim 15, further comprising upgrading software of the distributed system using the differential upgrade data.
